(19) United States
(12) Patent Application Publication
(10) Pub. No.: US 2024/0384778 A1
(43) Pub. Date: Nov. 21, 2024

(54) ADHESIVE BASED CABLE TIE MOUNT

(71) Applicants: TE Connectivity India Private Limited, Bangalore (IN); Tyco Electronics UK Ltd., Swindon (GB)

(72) Inventors: Manjesh Gowda Karabailu Nagalakkana Gowda, Bangalore (IN); Rejish Ambat, Bangalore (IN); Niranjan Hegde Kundapura, Bangalore (IN); Roy MacNaughton, Swindon (GB)

(21) Appl. No.: 18/660,629

(22) Filed: May 10, 2024

(30) Foreign Application Priority Data
May 16, 2023 (IN) 202341034358

(51) Int. Cl. F16G 11/00; F16L 3/14

(52) U.S. Cl. CPC F16G 11/00; F16L 3/14

(57) ABSTRACT

An adhesive based cable tie mount for attaching on a mounting surface and thereby mount cable ties to tie plurality of cable wires includes a top surface, a bottom surface, and a receiving cut-out portion formed between the top surface and the bottom surface. The top surface comprises a first end, a second end and a central portion for placing the cable wires. The top surface further has a predefined slanting towards a central portion. The bottom surface is configured to be attached with the mounting surface. A plurality of nubs of predefined dimension are disposed in a spaced apart manner on the bottom surface. The define a bond-line thickness between the bottom surface and sad mounting surface. The receiving cut-out portion is formed to accommodate the cable ties therein.

### CROSS REFERENCE TO RELATED APPLICATIONS

This application claims the benefit of IN application No. 202341034358, filed 16 May 2023, the subject matter of which is herein incorporated by reference in its entirety.

### BACKGROUND OF THE INVENTION

The subject matter herein in general relates to securing and organizing the management of cables in a neat and tidy manner at professional and personal settings. More particularly, the subject matter herein relates to cable tie mounts having adhesive based bonding surfaces, and their improvement regarding securing them to a mounting surface.

A cable tie mount is generally referred to as a small device usually made of plastic or composite, used to secure cables involving cable ties such as zip ties and thereby mounting them along a surface so that they may traverse a predetermined course. Over the years these cable tie mounts have replaced the conventional methods of securing cables with fasteners such as clamps, which were required to be attached with the mounting surface by making holes or some other type of deformations. Now, these holes and/or deformations are unacceptable in body panels of certain ground vehicles, air crafts, space-bound vehicles used in aerospace etc. as they compromise their structural integrity thereof.

Thus the cable tie mount comprises bonding surface that needs no screwing provision, and allows cables to be securely mounted at any location along the body panel i.e. mounting surface. The cable tie mounts generally are provided with a resting surface for the cables to fall in, and small channels or slots provided in a transverse direction to said resting surface. Ties, such as zip ties are inserted through the channels or slots and closed around the cables to tie them in a tidy manner. Further, there are known techniques of fixing the bonding surface of the cable tie mount to a mounting surface which includes adhesive backing using peel-off sticker. However, one has to be mindful about the weight that the cables have while choosing a cable tie mount with peel-off sticker.

More than often, plurality of wires having a substantial weight need to be mounted using these cable tie mounts. Accordingly, to provide a sturdy fixation of the cable tie mount, it is often considered to use a reliable adhesive, such as acrylic-based adhesive, rubber-based adhesive, epoxy adhesives, silicon adhesives etc. It is known in the art to put these types of adhesives on the bonding surface and thereupon place on the mounting surface without an applicator. The applicator generally is used to apply pressure to the cable tie mount against the mounting surface, giving the adhesive enough time for curing, ensuring a proper seating of the cable tie mount.

Conventionally, the adhesives, in gel or other semi-liquid formed are poured to the bonding surface and stuck on the mounting surface without considering the amount of adhesive and the weight increment because of the excess adhesive. However, in case of air-craft and space-bound vehicles, weight of the machines and components installed therein is of great concern, more so, because of the huge number of such tie mounts are used. Additional weight of said excess adhesive thus affects in a cumulative manner.

In known way of addressing such problem is to use a specific type of adhesive having glass beads. Due to the added glass beads as reinforcing agent, the adhesive property are increased which is one of the reasons of their application in automotive, aerospace and construction industries. These glass beads are generally spherical in shape, having a predetermined diameter. Thus these type of adhesives provide some dimensional standard regarding thickness of the adhesive used on the bonding surface. However, disadvantageously, one has to always depend on the standard set by the adhesive manufactures in addition to the possibility of uneven diameter of glass beads.

Furthermore, presently, remarkable improvements on numerous properties of adhesives are being carried out to drastically reduce the curing time thereof. Thus, it is often required or desired to use adhesive without glass beads to minimize the curing time while maintaining optimal thickness of the adhesive layer (bond-line thickness). Thus it is required to have predefined optimum bonding line thickness while installing cable tie mounts regardless of the type of adhesive used. However, there existing no known feature of the cable tie mount dedicated to meet the requirements as discussed.

With a view therefore to overcome the technical problems associated with conventional cable tie mount and its mounting method and means, there is a need for a cable tie mount working towards achieving an optimum bond-line thickness with adhesive even without glass beads, at the same time reducing the weight of the cable tie mount without compromising the structural integrity thereof.

### BRIEF DESCRIPTION OF THE INVENTION

Embodiments herein provide a cable tie mount where an optimum bond-line thickness of adhesive is achieved when installing a cable tie mount without depending on the choice of adhesive.

With the choice of adhesive having minimal curing time, embodiments herein install a cable tie mount without using applicator and thus reducing carbon foot-print and saving production cost at the same time.

Embodiments herein reduce the material weight from a construction perspective of the invented individual cable tie mount leading to a cumulative weight reduction when a huge number of cable tie mounts are put into action.

In an embodiment, an adhesive based cable tie mount for attaching on a mounting surface and thereby mounting cable ties to tie plurality of cable wires is provided including a top surface, a bottom surface, and a receiving cut-out portion formed between said top surface and the bottom surface. The top surface comprises a first end, a second end and a central portion for placing said cable wires. The top surface further has a predefined slanting towards a central portion. The bottom surface is configured to be attached with said mounting surface. Plurality of nubs of predefined dimension are disposed in a spaced apart manner on said bottom surface. The nubs define a bond-line thickness between said bottom surface and said mounting surface. The receiving cut-out portion is formed to accommodate said cable ties therein.

In an aspect, said plurality of nubs of predefined dimension are placed in symmetrical manner on said bottom surface.

In yet another aspect, said cable tie mount comprises at least one groove formed on said bottom surface, to reduce the weight.

In a further aspect, said cable tie mount comprises at least one notch formed at a peripheral end of said cable tie mount to guide said cable wires.

In yet another aspect, said top surface and said bottom surface being molded together as a single piece while maintaining said receiving cut-out portion.

### BRIEF DESCRIPTION OF THE DRAWINGS

For better understanding, exemplary embodiments will now be described with reference to the accompanying drawings. It will however be appreciated that the embodiments exemplified in the drawings are merely illustrative and not limitative to the scope of the invention, because it is quite possible, indeed often desirable, to introduce a number of variations in the embodiment that have been shown in the drawings. In the accompanying drawings:

FIG. 1 depicts a top perspective view of an adhesive cable tie mount according to an exemplary embodiment.

FIG. 2 depicts a perspective view of the adhesive cable tie mount turned upside down showing its bonding surface of the cable tie mount, according to an exemplary embodiment.

FIG. 3 depicts an isometric perspective view of a sectional cut-out portion of the adhesive cable tie mount according to an exemplary embodiment.

### DETAILED DESCRIPTION OF THE INVENTION

In the following, numerous specific details are set forth to provide a thorough description of exemplary embodiments. Those skilled in the art will recognize and appreciate that, despite of the detailed nature of the exemplary embodiment provided here; changes and modifications may be applied to said embodiments without limiting or departing from the generally intended scope. Like numbers refer to like elements throughout.

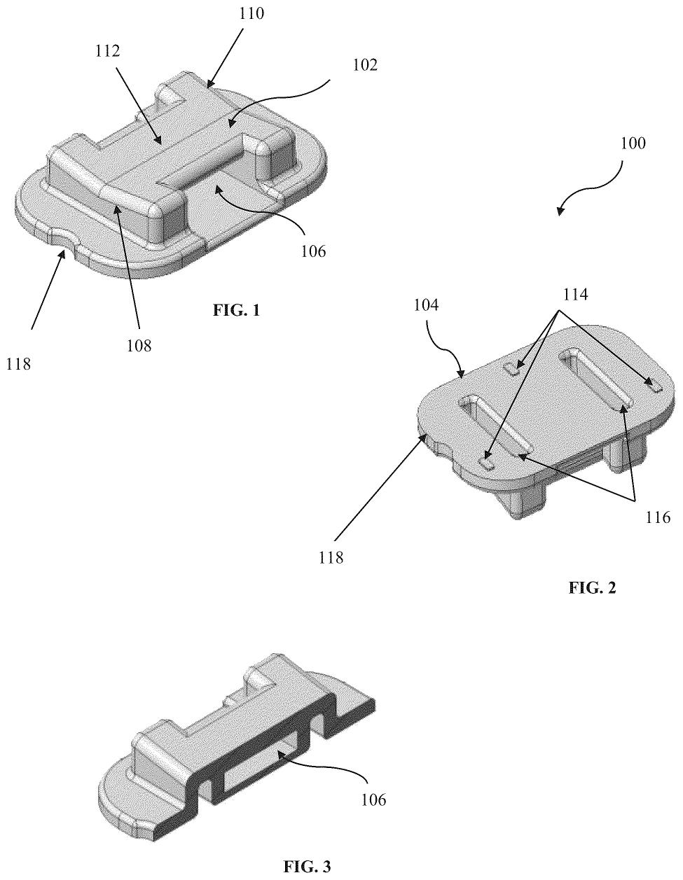

In the accompanying drawings, FIGS. 1 and 2 depict a top and a bottom perspective view respectively, of a structural diagram of a cable tie mount (100) to be attached on a mounting surface for carrying cable wires. The cable tie mount (100) comprises a top surface (102), a bottom surface (104), and a receiving cut-out portion (106) formed between said top surface (102) and the bottom surface (104). The top surface (102) is dedicated towards carrying the wire while being tied up with cable ties such as zip tie. On the other hand, the bottom surface (104) is purposed to be glued with a mounting surface such as on the body of an air-craft of space vehicle.

In an exemplary embodiment, the said top surface (102) and said bottom surface (104) being molded together as a single piece, where the top surface (102) is raised above the bottom surface (104) while maintaining said receiving cut-out portion (106). The receiving cut-out portion (106), as shown in FIG. 3, is thus defined as the region formed between the top surface (102) and the bottom surface (104). The top surface (102) is formed with a first end (108) and a second end (110) which are defined along the direction which the cable wire traverse. The cable ties are generally put through the cut-out portion (106) and tied around the cable wires.

A central portion (112) of the top surface (102) is defined as a central line joining said first end (108) and second end (110). The upper surface is slanted to create a bias towards said central portion (112) such that the cable wire may run along said central line. Further, a notch (118), such as ‘U’ or ‘V’-shaped, is formed at a peripheral end of said cable tie mount (100) to further guide said cable wires. The notch (118) may be formed in-line with the central line of said top surface (102).

The bottom surface (104) as illustrated in FIG. 2, is provided by plurality of nubs (114) that are disposed in a spaced apart manner. In the present embodiment, three nubs (114) are provided on the bottom surface (104) in a symmetrical manner. The functionality of said nubs (114) are not limitative to their number, placement or dimension. The dimension or extension of this nubs (114) are selected based on the requirement of the installation site.

As an adhesive is put on the bottom surface (104) and the cable tie mount (100) is pressed against the mounting surface, a bond-line thickness or gap is created between the mounting surface and the bottom surface (104). The gap is defined by the dimension of said nubs (114), which in turn also defines the optimum thickness of adhesive layer between the mounting surface and said bottom surface (104). For the purpose of attaching said cable tie mount (100) with glass bead type adhesive, the dimension of said nubs (114) can also the chosen in-line with the dimension of the glass beads.

Further, as shown in FIG. 3, grooves (116) are formed on said bottom surface (104) in a spaced apart manner. These grooves (116) are formed in carving out material from the bottom surface (104) while maintaining the structural integrity. These grooves (116) cause reduction of weight of individual cable tie mount (100).

As already mentioned, the foregoing description is illustrative of the invention and not limitative to its scope, because it will be apparent to persons skilled in the art to devise other alternative embodiments without departing from the broad ambit of the disclosures made herein.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112 (f), unless and until such claim limitations expressly use the phrase “means for” followed by a statement of function void of further structure.

What is claimed is:

1. An adhesive based cable tie mount for attaching on a mounting surface and thereby mount cable ties to tie a plurality of cable wires, wherein said cable tie mount comprising:
a top surface comprising a first end, a second end and a central portion for placing said cable wires;
a bottom surface configured to be attached with said mounting surface, said bottom surface comprises a plurality of nubs of predefined dimension disposed in a spaced apart manner whereby said nubs define a bond-line thickness between said bottom surface and said mounting surface; and
a receiving cut-out portion formed between said top surface and the bottom surface to accommodate said cable ties therein.

2. The cable tie mount as claimed in claim 1, wherein said plurality of nubs of predefined dimension are placed in a symmetrical manner on the said bottom surface.

3. The cable tie mount as claimed in claim 1, wherein said cable tie mount comprises at least one groove formed on said bottom surface.

4. The cable tie mount as claimed in claim 1, wherein said cable tie mount comprises at least one notch formed at a peripheral end of said cable tie mount to guide said cable wires.

5. The cable tie mount as claimed in claim 1, wherein said top surface is provided with a predefined slanting towards said central portion of said top surface extending between said first end and said second end.

6. The cable tie mount as claimed in claim 1, wherein said top surface and said bottom surface being molded together as a single piece while maintaining said receiving cut-out portion.

7. The cable tie mount as claimed in claim 2, wherein said cable tie mount comprises at least one groove formed on said bottom surface.

8. The cable tie mount as claimed in claim 2, wherein said cable tie mount comprises at least one notch formed at a peripheral end of said cable tie mount to guide said cable wires.

9. The cable tie mount as claimed in claim 2, wherein said top surface is provided with a predefined slanting towards said central portion of said top surface extending between said first end and said second end.

10. The cable tie mount as claimed in claim 2, wherein said top surface and said bottom surface being molded together as a single piece while maintaining said receiving cut-out portion.

11. The cable tie mount as claimed in claim 3, wherein said cable tie mount comprises at least one notch formed at a peripheral end of said cable tie mount to guide said cable wires.

12. The cable tie mount as claimed in claim 3, wherein said top surface is provided with a predefined slanting towards said central portion of said top surface extending between said first end and said second end.

13. The cable tie mount as claimed in claim 3, wherein said top surface and said bottom surface being molded together as a single piece while maintaining said receiving cut-out portion.

14. The cable tie mount as claimed in claim 4, wherein said top surface is provided with a predefined slanting towards said central portion of said top surface extending between said first end and said second end.

15. The cable tie mount as claimed in claim 4, wherein said top surface and said bottom surface being molded together as a single piece while maintaining said receiving cut-out portion.

16. The cable tie mount as claimed in claim 5, wherein said top surface and said bottom surface being molded together as a single piece while maintaining said receiving cut-out portion.
